(19) United States
(12) Patent Application Publication
(10) Pub. No.: US 2006/0117011 A1
(43) Pub. Date: Jun. 1, 2006

(54) Database for ownership and authenticity validation, systems including same and methods of use thereof

(75) Inventor: Ben-Zion Arbel, Tel Aviv (IL)

Correspondence Address: DR. MARK FRIEDMAN LTD.;C/o Bill Polkinghom, 9003 Florin Way, Upper Marlboro, MD, 20772, US

(73) Assignee: SWIFTIFIND LTD.

(21) Appl. No.: 10/999,995

(22) Filed: Dec. 1, 2004

(51) Int. Cl. G06F 17/30

(52) U.S. Cl. 707/9

(57) ABSTRACT

A database for ownership and authenticity validation of a plurality of items. The database permits entry of individual identification information about each item of the plurality. The database may communicate with user clients for a variety of purposes. This communication facilitates retrieval of individual identification information for one or more items in response to a query containing search criteria, updating individual identification information of at least one specific item and adding individual identification information pertaining to at least one new specific item. The database may be incorpoated into a computerized system including user clients. Use of the system constitutes one or more claimed methods. Issues of unauthorized production, insurance fraud and trafficking in stolen goods are addressed by the invention.

### FIELD AND BACKGROUND OF THE INVENTION

The present invention relates to a database for ownership and authenticity validation, systems including same and methods of use thereof and, more particularly, to a database which reduces the risk of fraud, counterfeiting and misrepresentation in secondary trade in items. The database further provides an important tool for law enforcement agencies and/or insurance underwriters in identifying and recovering lost or stolen goods.

The Internet has transformed the world into a Global Village in which trade in a wide variety of types of goods between individuals, businesses and clearinghouses, is both rapid and easy. However, this rapid and easy trade generally offers no assurance to the buyer that the seller is a legitimate owner of the goods being sold. Further, there is generally no assurance that the goods being sold are, in fact, what they are purported to be.

Limted solutions to these problems have been previously proposed. For example, U.S. Pat. No. 6,304,853 to Malnekoff teaches use of a database of pricing parameters to provide rapid price appraisals for gemstones. The Malnekoff patent fails to teach storage of data on specific gemstones, including ownership data and/or unique identification data, in a database for subsequent search and/or retrieval. Thus, this patent fails to teach authentication or validation of a gemstone offered for sale. Further, the Malnekoff patent has, as an inherent disadvantage, a strict limitation to gemstones, as opposed to other types of durable goods.

U.S. Pat. No. 5,673338 to Deneberg teaches a method and system for determining the authenticity of an item such as an original work of art, an art print, valuable jewelry or other valuable item and utilizes images of one or more unique patterns of features, preferably at a microscopic level, as one or more “signatures” of the item. The image of this unique signature is recorded and stored electronically as data representing the unique pattern. The data are registered with identifying text and stored in a secure storage location, to prevent unauthorized duplication or use of the stored data. Following this registration and storage, an item presented as authentic can be examined microscopically at prescribed sites on the item where the original images were taken. Comparison is made at one or more of the sites, and a decision is made as to whether the item exhibits substantially identical features to those originally registered, so as to be the same authentic item. Comparison can be made electronically or visually/microscopically. The storage location can be a central location remote from local verification stations, with data transferred to and from local stations by telephone lines or other communication links. Denenberg fails to teach storage of ownership data on specific items in a database for subsequent search and/or retrieval.

Neither Denenberg nor Malnekoff teaches a solution to the problem of establishing that a purported owner of an item for sale is, in fact, the legitimate owner. Further, neither Denenberg nor Malnekoff teaches a means of preventing unauthorized production of mass produced items (i.e. conterfeit goods). Further, neither Denenberg nor Malnekoff teaches a means of recovering stolen goods. Further, neither Denenberg nor Malnekoff teaches a means of preventing a subsequent sale of an item after it has been reported as lost or stolen.

There is thus a widely recognized need for, and it would be highly advantageous to have, a database for ownership and authenticity validation, systems including same and methods of use thereof devoid of the above limitation(s).

### SUMMARY OF THE INVENTION

According to one aspect of the present invention there is provided a computerized system for ownership and authenticity validation of a plurality of items. The system includes: (a) a server containing a database, the database containing individual identification information about each of a specific item belonging to the plurality of items; (b) a plurality of user clients, each of the user clients capable of communication with the database. Communication with the database facilitates performing at least one action selected from the group consisting of: (i) requesting at least a subset of the individual identification information; (ii) updating the individual identification information; and (iii) adding at least one new specific item to the database.

According to another aspect of the present invention there is provided a method for registration of a plurality of items as a means of validating ownership and authenticity, the method includes: (a) providing a database, the database designed and configured to contain individual identification information about each of a specific item belonging to the plurality of items; (b) entering into the database the individual identification; information about each of the specific item belonging to the plurality of items; and (c) permitting a user client belonging to a plurality of user clients to communicate with the database for purposes of performing at least one action selected from the group consisting of: (i) requesting at least a subset of the identification information; (ii) updating the identification information; and (iii) adding at least one new specific item to the database.

According to yet another aspect of the present invention there is provided a computerized database for ownership and authenticity validation of a plurality of items, the database designed and configured to:

(a) permit entry of individual identification information about each of a specific item belonging to the plurality of items; (b) communicate with a user client belonging to a plurality of user clients for purposes of performing at least one action selected from the group consisting of: (i) receiving a query containing at least one search criteria, the query resulting in retrieval of at least a subset of the individual identification information; (ii) processing a request to update the individual identification information of at least one of the specific items belonging to the plurality of items; and (iii) adding at least one new specific item to the database.

According to further features in preferred embodiments of the invention described below, the individual identification information includes at least one item selected from the group consisting of an identifying number for the specific item and an identifying mark for the specific item. One or more pictures of at least a portion of the specific item may be provided and stored in the database, although these pictures are not required for verification of ownership or authenticity of the item.

According to still further features in the described preferred embodiments individual identification information includes current ownership information for the specific item, status information for the specific item, an authorization key for the specific item and positional information for the specific item.

According to still further features in the described preferred embodiments the user clients are each independently operated by a party selected from the group consisting of a nominal producer, a manufacturing subcontractor, an importer, a wholesaler, a retailer, a buyer, a seller, an owner, a law enforcement agency and an insurance underwriter.

According to still further features in the described preferred embodiments the requesting at least a subset of identification information is effected by providing at least one search criteria.

According to still further features in the described preferred embodiments updating the identification information includes changing the current ownership information and a transfer of ownership of the specific item belonging to the plurality of items results.

According to still further features in the described preferred embodiments the updating the identification information includes altering the status information for the specific item to a status selected from the group consisting of lost and stolen.

According to still further features in the described preferred embodiments the system will not permit a transfer of ownership of the specific item once the status selected from the group consisting of lost and stolen has been applied.

According to still further features in the described preferred embodiments the adding the at least one new specific item to the database is performed by the nominal producer as a means of preventing unauthorized production.

According to still further features in the described preferred embodiments the specific items are mass produced items.

According to still further features in the described preferred embodiments the specific item is an individual item of jewelry.

According to still further features in the described preferred embodiments the specific item is a work of art.

According to still further features in the described preferred embodiments the specific item is a gemstone.

According to still further features in the described preferred embodiments the specific item is a collectible.

According to still further features in the described preferred embodiments the entering the individual identification information includes entering at least one item selected from the group consisting of an identifying number for the specific item and an identifying mark for the specific item.

According to still further features in the described preferred embodiments the entering the individual identification information includes entering at least one item selected from the group consisting of current ownership information for the specific item, status information for the specific item, an authorization key for the specific item and positional information for the specific item.

According to still further features in the described preferred embodiments each of the user client belonging to the plurality of user clients are independently operated by a party selected from the group consisting of a nominal producer, a manufacturing subcontractor, an importer, a wholesaler, a retailer, a buyer, a seller, an owner, a law enforcement agency and an insurance underwriter.

According to still further features in the described preferred embodiments the requesting at least a subset of identification information is effected by querying the database with at least one search criteria According to still further features in the described preferred embodiments the updating the identification information includes changing the current ownership information and a transfer of ownership of the specific item belonging to the plurality of items results.

According to still further features in the described preferred embodiments the updating the identification information includes altering the status information for the specific item to a status selected from the group consisting of lost and stolen.

According to still further features in the described preferred embodiments a transfer of ownership of the specific item is permitted if a current status of the specific item is not lost and not stolen; and a transfer of ownership of the specific item is not permitted if a current status of the specific item is a member of the group consisting of lost and stolen.

According to still further features in the described preferred embodiments the adding the at least one new specific item to the database is performed by the nominal producer as a means of preventing unauthorized production.

The present invention successfully addresses the shortcomings of the presently known configurations by providing a database for ownership and authenticity validation, systems including same and methods of use thereof which can, in its various embodiments, address issues of counterfeit production, insurance fraud and trafficking in stolen goods.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by one or several computers, using any suitable operating system. In any case, selected steps of the method and system of the invention could be described as being performed by one or more data processors, communicating with each other, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic diagram of components of a system according to the present invention.

FIG. 2 is a simplified flow diagram illustrating events associated with performance of a method according to the present invention.

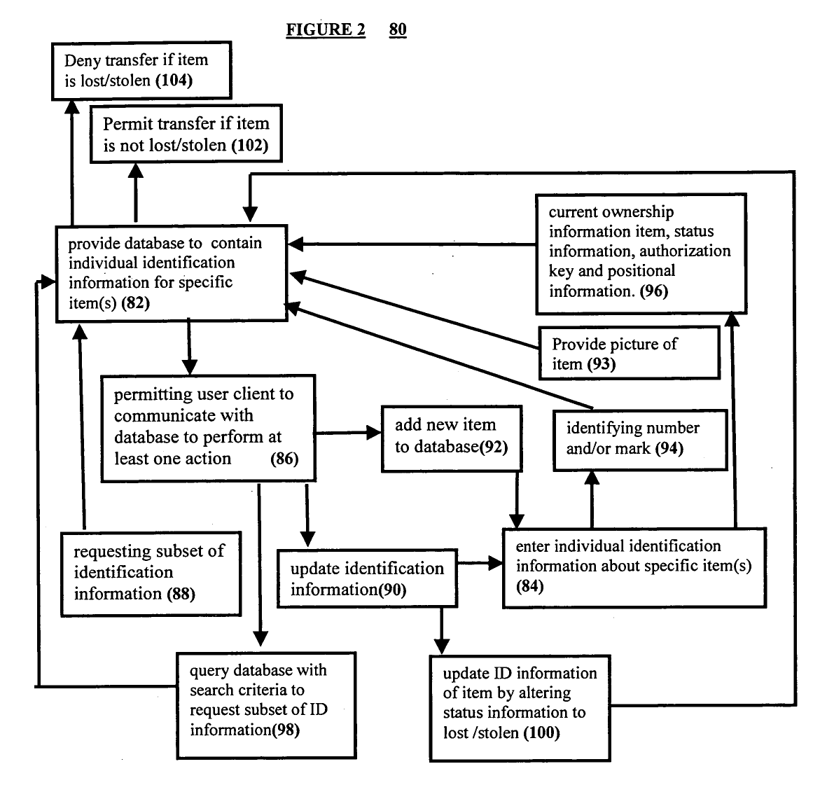

### DESCRIPTION OF THE PREFERRED EMBODIMENTS

The present invention is of a database for ownership and authenticity validation, systems including same and methods of use thereof.

Specifically, the present invention can be used to reduce the risk of fraud, counterfeiting and misrepresentation in secondary trade in items.

Alternately, or additionally, the database further provides an important tool for law enforcement agencies and/or insurance underwriters in identifying and recovering lost or stolen goods.

The principles and operation of a database for ownership and authenticity validation, systems including same and methods of use thereof according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase 37 user client” generally refers to a computer and includes, but is not limited to, personal computers (PC) having an operating system such as DOS, Windows™, OS/2 ™ or Linux; Macintosh™, Palm OS™, EPOC™ computers; computers having JAVA™-OS as the operating system; and graphical workstations such as the computers of Sun Microsystems™ and Silicon Graphics™, and other computers having some version of the UNIX operating system such as AIX™ or SOLARISTM™ of Sun Microsystems™; or any other known and available operating system; personal digital assistants (PDA), cellular telephones having computer capabilities, a telephone having computer capabilities and Web TVs, each of which is known to include an inherent or connectable display device.

For purposes of this specification and the accompanying claims, the term “server” refers to any computing machine capable of exchanging data with at least one other computing machine. A single server may comprise an individual computing machine or a plurality of such machines acting in concert to perm a function requested by at least one other computing machine.

For purposes of this specification and the accompanying claims, the term “Windows™” includes but is not limited to Windows 95™, Windows 2000™ Windows 3.x™ in which “x” is an integer such as “1”, Windows NT™, Windows 98™, Windows CE™ and Windows XT™, any upgraded versions of these operating systems by Microsoft Corp (USA) and/or window managers for the graphical X Windows system for UNIX based operating systems and/or its variants such as Linux.

For purposes of this specification and the accompanying claims, the phrase “Web browser” or “browser”, unless otherwise indicated, refers to any software program which can display text, graphics, or both, as well as display video, and/or play sounds, from Web pages on World Wide Web sites and or local files.

For purposes of this specification and the accompanying claims, the phrase “Web page” refers to any document written in a “mark-up language” or “script language”, or any programming language or tool. For purposes of this specification and the accompanying claims, the phrase “mark up language” includes, but is not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator). Script languages include, but are not limited to, CGI, PERL, VB Script, JavaScript, ASP.

For purposes of this specification and the accompanying claims, the term “Web site” refers to at least one Web page, and preferably a plurality of Web pages, virtually connected to form a coherent group.

For purposes of this specification and the accompanying claims, the term “Web server”or “server”, unless otherwise indicated, refers to a server for providing one or more Web pages to a Web browser upon request.

For purposes of this specification and the accompanying claims, the phrase “display a Web page” includes all actions necessary to render at least a portion of the information on the Web page available to the computer user. As such, the phrase includes, but is not limited to, the static visual display of static textual or graphical information, the audible production of audio information, the animated visual display of animation and the visual display of video stream data.

For purposes of this specification and the accompanying claims, the phrase “search engine” refers to any file, database or any content storage resource operating on a network server and being capable of receiving a query and responding thereto. Examples of search engines include, but are not limited to, www.yahoo.com, www.snap.com. www.lycos.com, www.hotbot.com, www.altavista.com, the PubMed server of the NCBI (www.ncbi.nlm.nih.gov/PubMed/medline.html), the database of the USPTO (www.uspto.gov/patft/index.html), the Internet movie database (www.imdb.com) and Online Mendelian Inheritance in Man (www.ncbi.nlm.nih.gov/Omimi/).

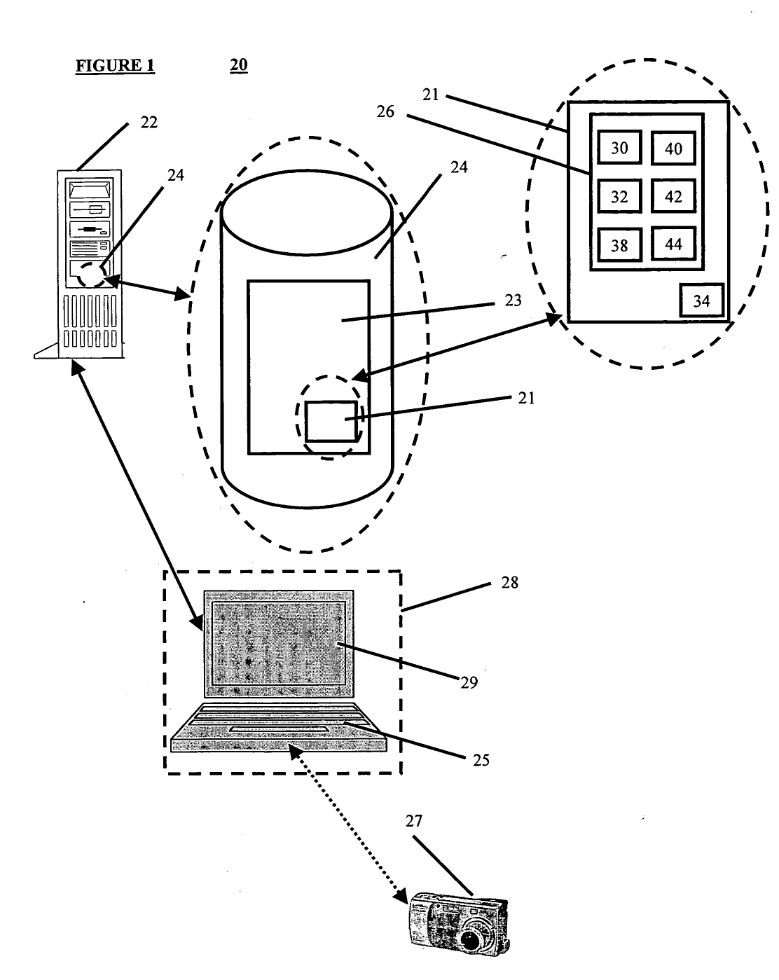

Referring now to the drawings, FIG. 1 illustrates a computerized system 20 for ownership and authenticity validation of a plurality of items 23. System 20 includes a web-server 22 containing a database 24. Database 24 contains individual identification information 26 about each specific item 21 belonging to the plurality of items 23.

System 20 further includes a plurality of user clients 28 (only one is pictured for simplicity). Each user client 28 is capable of communication with database 24 residing on web-server 22 through any available channel of communication. For purposes of this specification and the accompanying claims, the phrase “channel of communication” refers to a telephone connection, a cellular telephone connection, an Internet connection, an infrared frequency transmission connection, a local area network connection, a radio frequency connection, a fiber-optic connection or a connection by a wire. Inherent in the idea of a communication channel is an open status during which data transmission may occur. In some cases, communication channels may also have a closed status during which no data transmission may occur.

Communication with database 24, through server 22 facilitates actions to be performed from user clients 28. These actions include, but are not limited to, requesting at least a subset of the individual identification information, updating the individual identification information and adding at least one new specific item 21 to the database.

Communication with database 24 is optionally, but preferably conducted using a graphical user interface (GUI), most preferably in a window of a web browser presented on display 29. The GUI would preferably be organized in one or more forms with data entry options and/or free text fields that help a user communicate efficiently with database 24. Entry of data is via any data input device 25, for example a keyboard. In cases where a query is presented to database 24, the response is preferably presented as a web page in the same GUI. Optionally, but preferably, pictures 34 of items 21 are captured with digital camera 27 and relayed through user client 28 and server 22 to database 24.

The individual identification information 26 preferably includes one or more of an identifying number 30 for the specific item 21 and an identifying mark 32 for the specific item 21. Optionally, one or more pictures 34 of at least a portion of the specific item 21 may be stored in database 24 although these pictures 34 are not required for ownership and authenticity validation.

Identifying number 30 may be, for example, a serial number applied to mass produced item at the time of manufacture, or a number within a series (e.g. 50/500 for an authorized print of an art work) or a number applied to an item after purchase by an owner (e.g. social secuity number, driver's license number or telephone number).

Identifying mark 32 may be, for example, a laser tag applied to an item such as a gemstone. Laser tags may be applied, for example by equipment such as DiaScribe (Sarin; Ramat-Gan, Israel). Alternately, but also preferably, watermarking technology may be employed (e.g. Telford, Shropshire, United Kingdom).

Most preferably, individual identification information 26 includes current ownership information 38 for the specific item 21, status information 40 for the specific item 21, an authorization key 42 for the specific item 21 and positional information 44 for the specific item 21.

Optionally, but preferably, current ownership information 38 for the specific item 21 and/or status information 40 for the specific item 21 and/or authorization key 42 for the specific item 21 and/or positional information 44 for the specific item 21 are stored in a secure portion of database 24. Such a practice prevents unauthorized access to, and/or alteration of, this informatiuon. To that end, it may often be advantageous to divide web-server 22 and/or dastabse 24 into two, or more, physically distinct portions. One of ordinary skill in the art of computer science will be able to accomplish this division while allowing web-server 22 and/or dastabse 24 to apparently function as a single entity.

Web-server 22 and database 24 are preferably protected, using known security measures, against unauthorized access. Known secuity measures include, but are not limited to, applying different access privileges to different users. Users may be defined by User ID/password, by the user clients they operate or by other means.

It will be appreciated that according to some preferred embodiments of the invention, current ownership information 38 will designate a legal entity (e.g. company, store or museum) as opposed to a private individual. While the present invention is expected to find some utility in registration of items with a value in excess $10,000, it is a preferred embodiment of the invention to enter identification information 26 in database 24 for items with a value between $100 and $10,000, more preferably with a value between $100 and $5,000 and most preferably with a value between $100 and $1000.

Thus, the present invention provides for the first time, a database 24 suited designed specifically to catalog identification information 26, preferably including ownership information 38, pertaining to items of relatively low value.

According to various preferred embodiments of the invention, user clients 28 may be operated by a nominal producer, a manufacturing subcontractor, an importer, a wholesaler, a retailer, a buyer, a seller, an owner, a law enforcement agency or an insurance underwriter. It will be appreciated that, in many cases, sequential or subsequent operation of user clients 28 by one or more of these entities permits the present invention to achieve results which were not previously feasible.

For example, a private owner may employ system 20 to register individual identification information 26 of forty pieces of jewelry with an average value of $400 each in December 2004 in database 24. Preferably, identification information 26 includes watermark 32 as detailed hereinabove. If, in August 2006, the home of the private owner is robbed, and all of the jewelry is stolen, the owner would wish to file an insurance claim for $16,000 on the stolen jewelry. The owner may offer records of individual identification information 26 from database 24 which predate the robbery as proof of ownership of the stolen jewellry.

Preferably, the private owner of the stolen jewellry updates 90 identification information 26 by altering the status information for the specific item 21 to a status of lost/stolen immediately following the burglary.

According to a most preferred embodiment of the invention, system 20 will not permit a transfer of ownership of the specific item 21 once the status of lost or stolen has been applied. Such practice greatly increases the probability that the item in question will be returned to its rightful owner.

The phrase “transfer of ownership” as used in this specification and the accompanying claims refers equally to a situation in which a first party transfers ownership directly to a second party (e.g. by sale or by gift) and to a situation in second party acquires ownership without knowledge of the first part (e.g. following loss or theft of the item.

The insurance underwriter or a law enforcement agency, in turn, may use database 24 to search for individual identification information 26 which match the stolen pieces of jewellry. Such practice would facilitate recovery of the stolen jewelry if it is subsequently registered by another owner or if an attempt is made to sell it. It will be appreciated that current law enforcement databases are typically restricted to defined geographic regions. The present invention, by use of server 22 which is available to user clients 28 on the Internet, has no such geographic limitation.

Preferably, a potential buyer, such as a pawnshop owner, would query database 24 with at least a portion of identification information 26 (e.g. watermark 32) and determine that the item 21 offered for sale is defined in database 24 as stolen. In such a case, the pawnshop owner might hold item 21 while contacting law enforcement officials. This serves to facilitate recovery of stolen items 21, and possibly also facilitates apprehension of the thief that has presumably been photographed by security cameras in the pawnshop.

Alternately, but also preferably, the insurance underwriter or a law enforcement agency may request at least a subset of identification information 26 by providing at least one search criteria 46. To that end, user clients 28 will communicate with database 24 via a graphical user interface with defined data entry fields. It is important to note that this approach does not require the use of watermark 32. In the example provided above the search criteria might include a general category designation of jewellry, followed by a value designation of $100 to $500 followed by descriptive information of one of the more unique of the 40 pieces (e.g. man's signet ring, initials RJ with a one eighth carat red garnet in the upper left corner). Such a search might return five items. Three items could be ruled out because they were registered before the date of the robbery. One of these three is the original registration of the stolen item by the person making the insurance claim from December 2004, updated to “stolen” in August 2006. Another might be ruled out because it is geographically too far away from the site of the robbery (e.g. on another continent). The fifth item could be a registration from a pawnshop 600 miles from where the robbery occurred five months after the robbery. A subsequent search using the name of the pawnshop as current ownership 38 criteria reveals additional pieces of the stolen jewellry. This illustrates that the present invention greatly reduces the effectiveness of letting stolen goods “cool off” and or crossing local or state borders before reselling them.

Thus it is clear that the present invention has utility if the specific item 21 is an individual item of jewelry such as, for example, rings, bracelets, earrings, pendants, lockets, necklaces, anklets, pins, brooches, charms/charm bracelets, brooches or tiaras.

As another example of the utility of the present invention, updating identification information 26 includes changing the current ownership information 38 and a transfer of ownership of the specific item 21 belonging to the plurality of items 23 results. This use of the invention permits establishment of a chain of ownership and is expected to find especial utility in the re-sale market, especially for antiques, collectibles, etc. While a chain of ownership going back to the original purchase is preferred, even a chain of ownership which goes back several years has value, especially if it includes a reputable dealer in the relevant category of items.

The term “collectible” as used in this specification and the accompanying claims includes, but is not limited to, books, manuscripts, furniture, lamps, antiques, textiles, clothing, accessories, coins (antique or modern), bullion, banknotes, stock certificates, bonds, stamps, glass item (e.g. Tiffany lampshade), Ivory (e.g. scrimshaw or carvings), costumes, masks, fans, dolls, pottery, ceramics, porcelain, game sets, rugs, carpets, silver, siverplate. scientific instruments, medical instruments, fossils, geodes, religious icons, musical instruments and garden ornaments.

Thus, a purchaser of of a new collectible item such as issue number one of a comic book series “Mushroom Man” might register the acquisition in database 24. Alternately, and preferably, the publishers of Mushroom Man might number the copies of the comic book. This would allow the publishers to assign ownership of 100 book lots of Mushroom Man to various retail outlets. The retail outlets would then transfer ownership of individual copies to purchasers at the time of sale. Such practice prevents both unauthorized production and subsequent counterfeiting by assuring that all of the original production run of Mushroom Man is registered in database 24 from the time that printing is contracted to the printer by the publisher.

Such a strategy might be similarly applied to a wide variety of mass produced items including but not limited to automotive electronics, DVD Players/Recorders, Digital Video Recorders, PVR, GPS Devices, Home Audio devices, Home Theatre systems and/or components, MP3 Portable Audio devices (e.g. iPOD®, PDAs, Handheld PCs, Satellite dishes, Cable TV equipment, Telephones, Cell-phones, Pagers, Televisions, display screens, VCRs, Vintage Electronics, bicycles, sports equipment, watches, Binoculars, Telescopes, Camcorders, Digital Cameras, Film Cameras, Lenses & Accessories, Lighting and Studio Equipment, Professional Video Equipment, Projection Equipment, Vintage cameras, clothing, furniture, shoes, firearms, swords, knives and musical instrument.

Additional utility of system 20 may be realized if the item is a work of art such as, for example, digital art, drawings, folk/oriental art, mixed media, paintings, miniatures, photographic images, posters, prints, sculpture, carvings and self-representing artists. Again, the greatest advantage of system 20 is realized if the artist registers the work of art in database 24 at the time of creation. However, registration of the work of art after the first, or any subsequent, sale still serves to establish a chain of ownership. For digital art, use of finger printing and watermarking technologies (e.g. SmartWater solution of SmartWater Technology, Shropshire, United Kingdom) are optionally but preferably employed as part of individual identification information 26. Assuming that the artist registered one thousand copies of a digital image as they were produced sold, the artist could search database 24 to see if illegal copying/distribution were occuring. Thus, system 20 has, as an additional advantage, a capacity to protect against copyright infringement. It will be appreciated that system 20 can be employed to obviate the need for the technology employed in U.S. Pat. No. 5,673,338 for authentication. As described hereinabove, an uninterrupted chain of ownership back to the day of production of an artwork establishes the authenticity of the work in question.

System 20 is expected to find additional utility when the specific item 21 registered in database 24 is a gemstone such as, for example, a diamond, a pearl, a ruby, a sapphire or an emerald.

Identification information 26 may include laser marking applied by marking products, such as DiaScribe of Sarin located in Ramat-Gan, Israel. Such laser marking may be applied to items by any 3^{rd} party technology without significantly affecting the performance of system 20. Identification information 26 may include watermarking applied by marking products, such as SmartWater solution of SmartWater Technology located in Shropshire, United Kingdom. Such watermarking may be applied to items by any 3^{rd} party technology.

The present invention is further embodied by method 80 for registration of a plurality of items 23 as a means of validating ownership and authenticity. Method 80 includes providing 82 database 24 designed and configured to contain individual identification information 26 about each of a specific item 21 belonging to the plurality of items 23.

Method 80 further includes entering 84 into database 24 the individual identification information 26 about each of the specific item 21 belonging to the plurality of items 23.

Method 80 further includes permitting 86 user client 28 belonging to a plurality of user clients 28 to communicate with database 24 for purposes of performing at least one action.

According to various embodiments of method 80, the actions include, but are not limited to:
requesting 88 at least a subset of identification information 26;
updating 90 the identification information 26; and
adding 92 identification information 26 pertaining to at least one new specific item 21 to database 24.

Detailed examples of requesting 88, updating 90 and adding 92 are provided hereinabove in the context of the explanation of system 20. It will be appreciated that use of system 20 as described hereinabove constitutes practice of method 80.

As detailed hereinabove, adding 92 the at least one new specific item 21 to the database 24 is preferably performed by a nominal (e.g. publisher) or actual (e.g. artist) producer as a means of preventing unauthorized production.

Preferably, entering 94 individual identification information 26 includes entering one or more of: an identifying number 30 for the specific item 21 and an identifying mark 32 for the specific item 21. As detailed hereinabove, pictures 34 of at least a portion of the may be stored in database 24 but are not required for validation of ownership.

Alternately, or additionally, entering 96 individual identification information 26 includes entering one or more of: current ownership information 38 for the specific item 21, status information 40 for the specific item 21, an authorization key 42 for the specific item 21 and positional information 44 for the specific item 21.

As detailed hereinabove, method 80 is preferably practiced by a variety of interestred parties including a nominal producer, a manufacturing subcontractor, an importer, a wholesaler, a retailer, a buyer, a seller, an owner, a law enforcement agency and an insurance underwriter. Each of these parties, by operating a user client 28 may access database 24. As detailed hereinabove, it is often successive use of system 20 by many parties with respect to the same item that imparts the unique utility of method 80.

Thus, according to method 80, any interested party may request 88 at least a subset of identification information 26 by querying 98 the database with at least one search criteria 46 as detailed hereinabove.

According to additional preferred embodiments of the invention, updating 90 identification information 26 includes changing the current ownership information and a transfer of ownership of the specific item 21 belonging to the plurality of items 23 results.

According to additional preferred embodiments of the invention, updating 90 identification information 26 includes altering 100 the status information for the specific item 21 to a status of lost and/or stolen.

Thus a transfer of ownership of the specific item 21 is permitted 102 if a current status of the specific item 21 is not lost and not stolen and a transfer of ownership of the specific item 21 is denied 104 if a current status of the specific item 21 either lost or stolen.

The invention is most simply embodied by computerized database 24 for ownership and authenticity validation of a plurality of items 23. Database 24 is designed and configured to permit entry of individual identification information 26 about each of a specific item 21 belonging to the plurality of items 23.

Database 24 is further designed and configured to communicate with user client 28 belonging to a plurality of user clients 28 for purposes of performing one or more actions.

These actions include, but are not limited to:
receiving a query containing at least one search criteria 46, the query resulting in retrieval of at least a subset of the individual identification information 26;
processing a request to update the individual identification information of at least one of the specific items 21 belonging to the plurality of items; and
adding individual identification information 26 pertaining to at least one new specific item 21 to the database 24.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed:

1. A computerized system for ownership and authenticity validation of a plurality of items, the system comprising:
(a) a web-server containing a database, said database containing individual identification information about each of a specific item belonging to the plurality of items;
(b) a plurality of user clients, each of said user clients capable of communication with said database for purposes of performing at least one action selected from the group consisting of:
(i) requesting at least a subset of said individual identification information;
(ii) updating said individual identification information; and
(iii) adding at least one new specific item to the database.

2. The system of claim 1, wherein said individual identification information includes at least one item selected from the group consisting of an identifying number for said specific item and an identifying mark for said specific item.

3. The system of claim 1, wherein said individual identification information includes current ownership-information for said specific item, status information for said specific item, an authorization key for said specific item and positional information for said specific item.

4. The system of claim 1, wherein said user clients are each independently operated by a party selected from the group consisting of a nominal producer, a manufacturing subcontractor, an importer, a wholesaler, a retailer, a buyer, a seller, an owner, a law enforcement agency and an insurance underwriter

5. The system of claim 1, wherein said requesting at least a subset of identification information is effected by providing at least one search criteria.

6. The system of claim 3, wherein said updating said identification information includes changing said current ownership information and a transfer of ownership of said specific item belonging to said plurality of items results.

7. The system of claim 3, wherein said updating said identification information includes altering said status information for said specific item to a status selected from the group consisting of lost and stolen.

8. The system of claim 7, wherein the system will not permit a transfer of ownership of said specific item once said status selected from the group consisting of lost and stolen has been applied.

9. The system of claim 4, wherein said adding said at least one new specific item to said database is performed by said nominal producer as a means of preventing unauthorized production.

10. The system of claim 1, wherein said specific items are mass produced items.

11. The system of claim 1, wherein said specific item is an individual item of jewelry.

12. The system of claim 1, wherein said specific item is a work of art.

13. The system of claim 1, wherein said specific item is a gemstone.

14. The system of claim 1, wherein said specific item is a collectible.

15. A method for registration of a plurality of items as a means of validating ownership and authenticity, the method comprising:
(a) providing a database, said database designed and configured to contain individual identification information about each of a specific item belonging to the plurality of items;
(b) entering into said database said individual identification; information about each of said specific item belonging to the plurality of items; and
(c) permitting a user client belonging to a plurality of user clients to communicate with said database for purposes of performing at least one action selected from the group consisting of:
(i) requesting at least a subset of said identification information;
(ii) updating said identification information; and
(iii) adding at least one new specific item to the database.

16. The method of claim 15, wherein said entering said individual identification information includes entering at least one item selected from the group consisting of an identifying number for said specific item and an identifying mark for said specific item.

17. The method of claim 15, wherein said entering said individual identification information includes entering at least one item selected from the group consisting of current ownership information for said specific item, status information for said specific item, an authorization key for said specific item and positional information for said specific item.

18. The method of claim 15, wherein each of said user client belonging to said plurality of user clients are independently operated by a party selected from the group consisting of a nominal producer, a manufacturing subcontractor, an importer, a wholesaler, a retailer, a buyer, a seller, an owner, a law enforcement agency and an insurance underwriter.

19. The method of claim 15, wherein said requesting at least a subset of identification information is effected by querying said database with at least one search criteria.

20. The method of claim 17, wherein said updating said identification information includes changing said current ownership information and a transfer of ownership of said specific item belonging to said plurality of items results.

21. The method of claim 17, wherein said updating said identification information includes altering said status information for said specific item to a status selected from the group consisting of lost and stolen.

22. The method of claim 21, wherein:
a transfer of ownership of said specific item is permitted if a current status of said specific item is not lost and not stolen; and
a transfer of ownership of said specific item is not permitted if a current status of said specific item is a member of the group consisting of lost and stolen.

23. The method of claim 18, wherein said adding said at least one new specific item to said database is performed by said nominal producer as a means of preventing unauthorized production.

24. A computerized database for ownership and authenticity validation of a plurality of items, the database designed and configured to:
(a) permit entry of individual identification information about each of a specific item belonging to the plurality of items;
(b) communicate with a user client belonging to a plurality of user clients for purposes of performing at least one action selected from the group consisting of:
(i) receiving a query containing at least one search criteria, said query resulting in retrieval of at least a subset of said individual identification information;
(ii) processing a request to update said individual identification information of at least one of said specific items belonging to the plurality of items; and
(iii) adding at least one new specific item to the database.
